(19) United States
(12) Patent Application Publication
(10) Pub. No.: US 2018/0004257 A1
(43) Pub. Date: Jan. 4, 2018

(54) EXPANSION CARD MOUNTING ASSEMBLY FOR CIRCUIT BOARD

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: WEN-HSIANG HUNG, New Taipei (TW); XIAO-XIA SHE, Wuhan (CN); CHING-JOU CHEN, New Taipei (TW)

(21) Appl. No.: 15/240,372

(22) Filed: Aug. 18, 2016

(30) Foreign Application Priority Data
Jul. 1, 2016 (CN) 201610508088.7

(51) Int. Cl. G06F 1/18

(52) U.S. Cl. CPC G06F 1/185

(57) ABSTRACT

A mounting assembly on a circuit board to accept and connect with expansion cards has a first flange and a second flange. The circuit board defines a first inserting slot near the first flange. The first inserting slot is configured to electronically receive a first expansion card or a second expansion card. A first distance is defined between an edge of the first expansion card near the second flange and the second flange itself when the first expansion card is inserted into the first inserting slot. A second distance is defined between an edge of the second expansion card near the second flange and the second flange itself when the second expansion card is inserted into the first inserting slot, the first distance being less than the second distance.

### FIELD

The subject matter herein generally relates to mounting assemblies.

### BACKGROUND

A circuit board assembly is used to receive a plurality of expansion cards with different lengths.

### BRIEF DESCRIPTION OF THE DRAWINGS

Implementations of the present technology will now be described, by way of example only, with reference to the attached figures.

FIG. 1 is an isometric, assembled view of one exemplary embodiment of an expansion card mounting assembly for circuit board.

FIG. 2 is a vertical view of the expansion card mounting assembly of FIG. 1.

FIG. 3 is an isometric, assembled view of the expansion card mounting assembly of FIG. 1, and an expansion card module inserted into the circuit board assembly.

FIG. 4 is a vertical view of the expansion card mounting assembly of FIG. 1, and a first expansion card inserted into the circuit board assembly.

FIG. 5 is a vertical view of the expansion card mounting assembly of FIG. 1, and a second expansion card inserted into the circuit board assembly.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

The present disclosure is described in relation to a circuit board assembly used to receive a plurality of expansion cards.

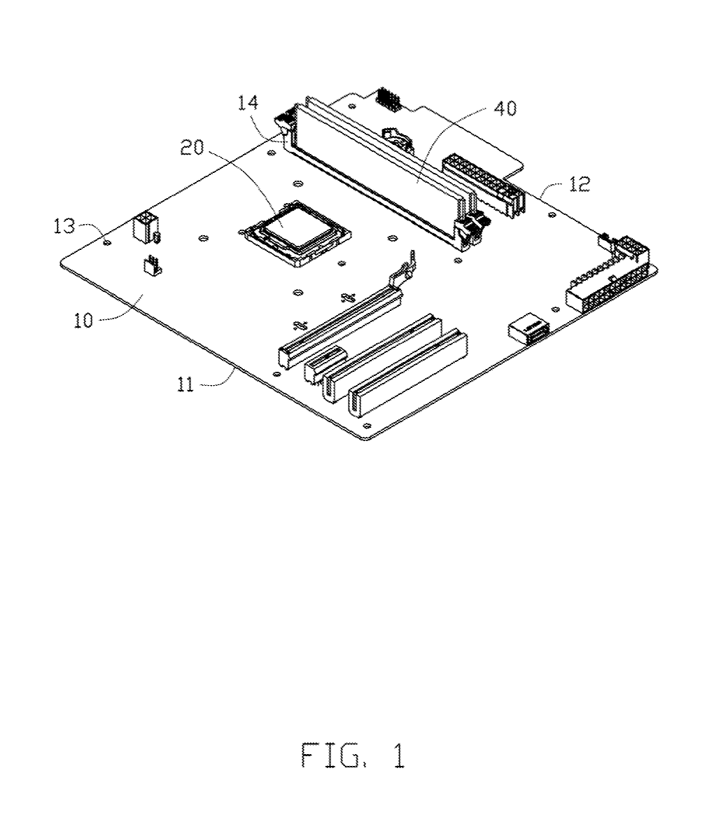

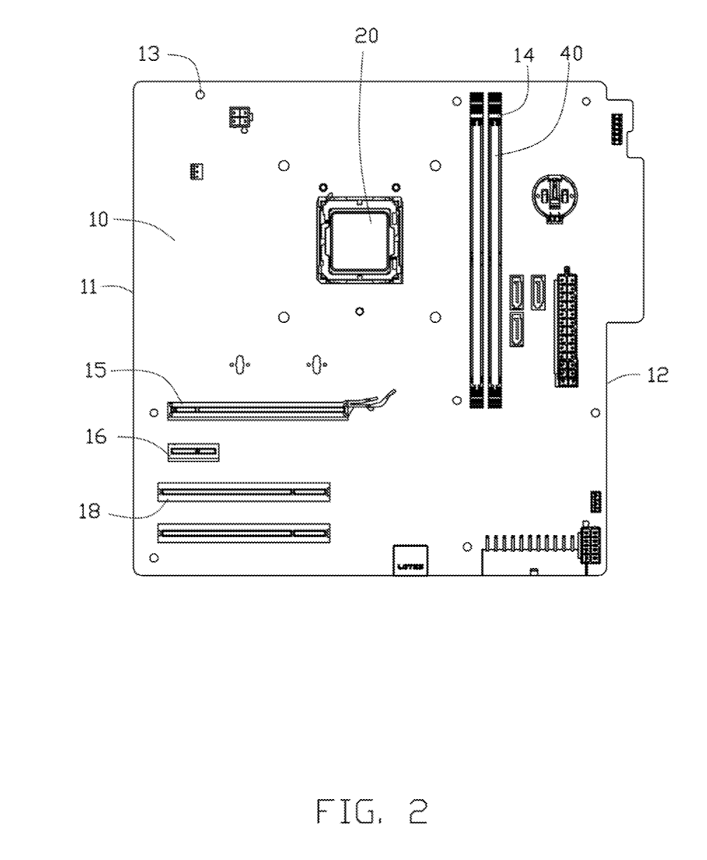

FIGS. 1-3 illustrate an exemplary embodiment of an expansion card mounting assembly for circuit board. The expansion card mounting assembly for circuit board comprises a circuit board assembly 100. The circuit board assembly 100 comprises a circuit board 10, a plurality of electronic devices 20, and an expansion card module 30. The plurality of electronic devices 20 are configured to be mounted on the circuit board 10. The expansion card module 30 comprises a plurality of expansion cards and the plurality of expansion cards are configured to be inserted into the circuit board 10. In at least one exemplary embodiment, the circuit board 10 is a motherboard, and the electronic device 20 comprises a central processing unit (CPU), an image processor, and a connector.

The circuit board 10 comprises a first flange 11 and a second flange 12. The first flange 11 is substantially parallel to the second flange 12. The circuit board 10 defines a plurality of mounting holes 13. A plurality of fasteners (not shown) can pass through the mounting holes 13 to secure the circuit board 10 to a chassis (not shown). The circuit board 10 defines a plurality of switching interfaces 14. A plurality of circuit board cards 40 can be inserted into the switching interfaces 14 to electronically connect to the circuit board 10.

The circuit board 10 defines at least one first inserting slot 15 near the first flange 11. In one exemplary embodiment, an opening direction of the first inserting slot 15 is substantially perpendicular to the circuit board 10; in another embodiment, the opening direction of the first inserting slot 15 is substantially parallel to the circuit board 10. An extending direction of the first inserting slot 15 is substantially perpendicular to an extending direction of each switching interface 14. A first distance is defined between a first edge of the first inserting slot 15 near the first flange 11 and the first flange 11. In at least one exemplary embodiment, the first distance is from about 15 to about 20 millimeters.

In one exemplary embodiment, the circuit board 10 further defines a second inserting slot 16 near the first flange 11 and two third inserting slots 18 near the first flange 11. An opening direction of the second inserting slot 16 and an opening direction of each third inserting slot 18 are substantially perpendicular to the circuit board 10. An extending direction of the second inserting slot 16 is substantially parallel to an extending direction of the first inserting slot 15. An extending direction of each third inserting slot 18 is substantially parallel to the extending direction of the first inserting slot 15 and the extending direction of the second inserting slot 16. The extending direction of the second inserting slot 16 and the extending direction of each third inserting slot 18 are substantially perpendicular to the extending direction of each switching interface 14. A second distance is defined between a second edge of the second inserting slot 16 near the first flange 11 and the first flange 11. A third distance is defined between a third edge of each third inserting slot 18 near the first flange 11 and the first flange 11. The second distance, equal to the third distance, is from about 15 to about 20 millimeters.

In one exemplary embodiment, the first distance is approximately 17 millimeters, the second and third distances are substantially the same as the first distance.

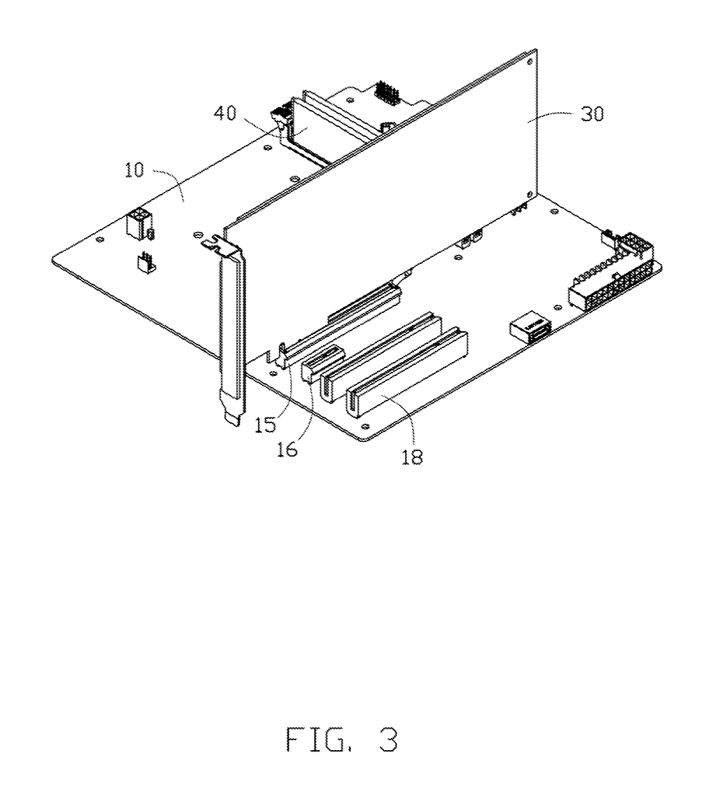

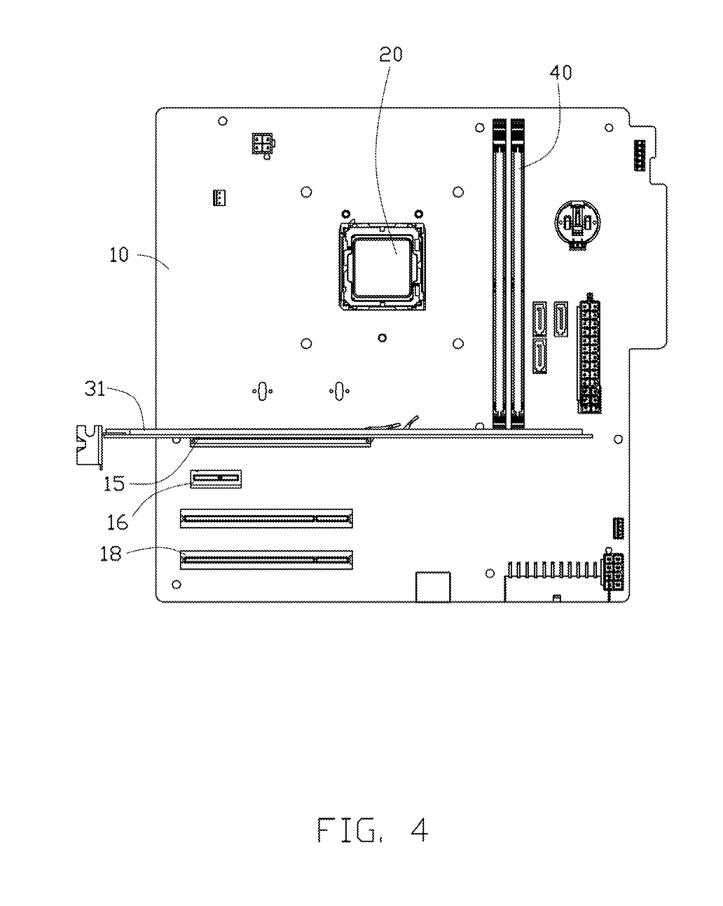

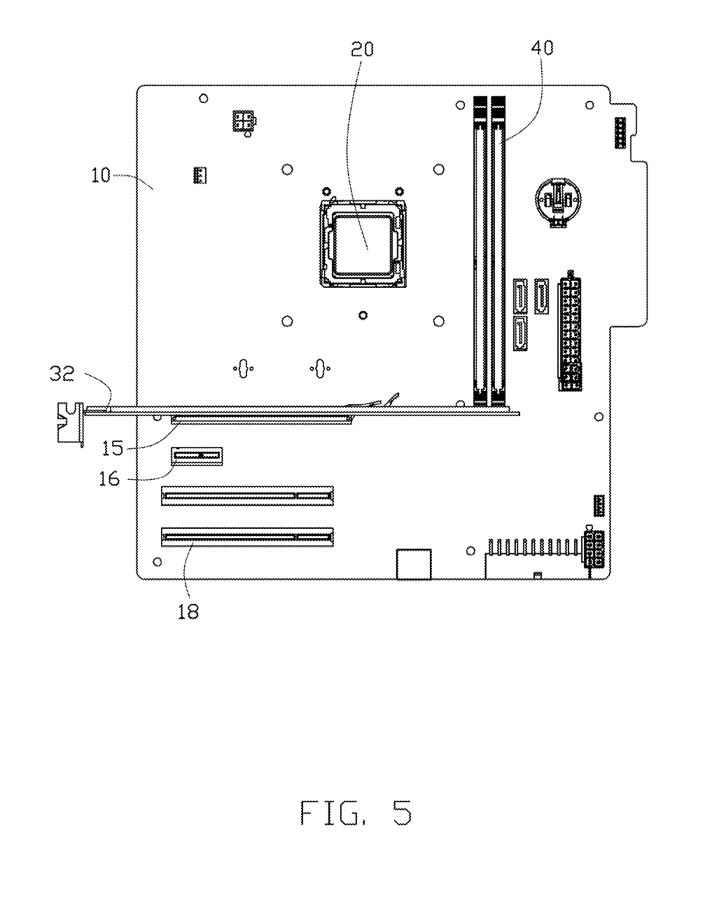

FIGS. 3-5, the expansion card module 30 comprises a first expansion card 31 and a second expansion card 32. A length of the second expansion card 32 is less than a length of the first expansion card 31. A fourth distance is defined between the first flange 11 and the second flange 12. The respective lengths of the first and second expansion cards 32 and 31 are less than the fourth distance. The first expansion card 31 can be inserted into the first inserting slot 15, or the second inserting slot 16, or the third inserting slot 18, to electronically connect to the circuit board 10. The second expansion card 32 can be inserted into the first inserting slot 15, when the first expansion card 31 is not inserted into the first inserting slot 15. The second expansion card 32 can be inserted into the second inserting slot 16, when the first expansion card 31 is not inserted into the second inserting slot 16. The second expansion card 32 can be inserted into the third inserting slot 18, when the first expansion card 31 is not inserted into the third inserting slot 18. The first expansion card 31 and the second expansion card 32 are substantially perpendicular to the circuit board 10. When the first expansion card 31 is inserted into the first inserting slot 15, a fifth distance is defined between a fourth edge of the first expansion card 31 near the second flange 12 and the second flange 12. When the second expansion card 32 is inserted into the first inserting slot 15, a sixth distance is defined between a fifth edge of the second expansion card 32 near the second flange 12 and the second flange 12. In one embodiment, the fifth distance is less than the sixth distance.

In the exemplary embodiment, the length of the first expansion card 31 is 10.5 inches and the length of the second expansion card 32 is 9.5 inches.

In one exemplary embodiment, the first expansion card 31 and the second expansion card 32 can be a display card, a network card, a sound card, or a capture card.

The first inserting slot 15, the second inserting slot 16, and the third inserting slot 18 can be an AGP inserting slot, a PCI inserting slot, a MINI PCI inserting slot, a PCI-E inserting slot, or a MINI PCI-E inserting slot.

In one exemplary embodiment, the first inserting slot 15, the second inserting slot 16, and the third inserting slot 18 can be located on different parts of the circuit board 10, thus a plurality of expansion cards with different lengths are capable of being mounted on the circuit board 10.

It is to be understood that even though numerous characteristics and advantages have been set forth in the foregoing description of embodiments, together with details of the structures and functions of the embodiments, the disclosure is illustrative only and changes may be made in detail, including in the matters of shape, size, and arrangement of parts within the principles of the disclosure to the full extent indicated by the broad general meaning of the terms in which the appended claims are expressed.

What is claimed is:

1. An expansion card mounting assembly for circuit board comprising:
a circuit board having:
a first flange;
a second flange; and
a first inserting slot near the first flange; and
wherein the first inserting slot is configured to electronically receive a first expansion card and electronically receive a second expansion card;
wherein a first distance is defined between a first edge of the first expansion card near the second flange and the second flange, when the first expansion card is inserted into the first inserting slot;
wherein a second distance is defined between a second edge of the second expansion card near the second flange and the second flange, when the second expansion card is inserted into the first inserting slot;
wherein the first distance is less than the second distance.

2. The expansion card mounting assembly of claim 1, wherein a third distance is defined between a third edge of the first inserting slot near the first flange and the first flange, and the third distance is from about 15 to about 20 millimeters.

3. The expansion card mounting assembly of claim 2, wherein a length of the second expansion card is less than a length of the first expansion card.

4. The expansion card mounting assembly of claim 3, wherein a fourth distance is defined between the first flange and the second flange, the length of the first expansion card is less than fourth distance.

5. The expansion card mounting assembly of claim 1, wherein the circuit board defines a second inserting slot near the first flange and the second inserting slot is substantially parallel to the first inserting slot.

6. The expansion card mounting assembly of claim 5, wherein the first expansion card and the second expansion card are inserted into the second inserting slot to electronically connect to the circuit board.

7. The expansion card mounting assembly of claim 5, wherein the circuit board defines at least one third inserting slot near the first flange and each third inserting slot is substantially parallel to the first inserting slot.

8. The expansion card mounting assembly of claim 7, wherein the first expansion card and the second expansion card are inserted into the third inserting slots to electronically connect to the circuit board.

9. The expansion card mounting assembly of claim 7, wherein the first inserting slot, the second inserting slot, and the third inserting slot is a PCI inserting slot.

10. The expansion card mounting assembly of claim 1, wherein the circuit board defines a plurality of mounting holes and a plurality of fasteners are capable of passing through the mounting holes to secure the circuit board to a chassis.

11. An expansion card mounting assembly for circuit board comprising:
a circuit board having:
a first flange;
a second flange; and
a first inserting slot near the first flange; and
a first expansion card configured to be electronically inserted into the first inserting slot; and
a second expansion card configured to be electronically inserted into the first inserting slot;
wherein a length of the second expansion card is less than a length of the first expansion card;
wherein a first distance is defined between a first edge of the first expansion card near the second flange and the second flange, when the first expansion card is inserted into the first inserting slot;
wherein a second distance is defined between a second edge of the second expansion card near the second flange and the second flange, when the second expansion card is inserted into the first inserting slot;
wherein the first distance is less than the second distance.

12. The expansion card mounting assembly of claim 11, wherein a third distance is defined between a third edge of the first inserting slot near the first flange and the first flange, and the third distance is from about 15 to about 20 millimeters.

13. The expansion card mounting assembly of claim 12, wherein a fourth distance is defined between the first flange and the second flange, a length of the second expansion card is less than fourth distance.

14. The expansion card mounting assembly of claim 11, wherein a fifth distance is defined between a fourth edge of the second inserting slot near the first flange and the first flange, and the fifth distance is from about 15 to about 20 millimeters.

15. The expansion card mounting assembly of claim 11, wherein the circuit board defines at least one second inserting slot near the first flange and each second inserting slot is substantially parallel to the first inserting slot.

16. The expansion card mounting assembly of claim 15, wherein the first expansion card and the second expansion card are inserted into the second inserting slots to electronically connect to the circuit board.

17. The expansion card mounting assembly of claim 15, wherein an opening direction of each second inserting slot is substantially perpendicular to the circuit board.

18. The expansion card mounting assembly of claim 15, wherein an extending direction of each second inserting slot is substantially parallel to an extending direction of the first inserting slot.

19. The expansion card mounting assembly of claim 18, wherein the circuit board defines a plurality of switching interfaces and a plurality of circuit board cards are inserted into the switching interfaces to electronically connect to the circuit board.

20. The expansion card mounting assembly of claim 19, wherein the extending direction of each second inserting slot is substantially perpendicular to an extending direction of each switching interface.
